(19) United States
(12) Patent Application Publication
(10) Pub. No.: US 2025/0078457 A1
(43) Pub. Date: Mar. 6, 2025

(54) OBJECT TRACKING METHOD AND DEVICE

(71) Applicant: INSTITUTE FOR INFORMATION INDUSTRY, Taipei City (TW)

(72) Inventors: Yu-Sheng TSENG, Taipei City (TW); Meng-Tsan LI, Taipei City (TW)

(73) Assignee: INSTITUTE FOR INFORMATION INDUSTRY, Taipei City (TW)

(21) Appl. No.: 18/385,881

(22) Filed: Oct. 31, 2023

(30) Foreign Application Priority Data
Aug. 30, 2023 (TW) 112132754

(51) Int. Cl. G06V 10/764; G06T 7/215; G06V 10/74; G06V 10/77

(52) U.S. Cl. CPC G06V 10/764; G06T 7/215; G06V 10/761; G06V 10/7715; G06T 2207/30242

(57) ABSTRACT

An object tracking method includes: extracting historical moving traces corresponding to historical objects from historical images, predicting predicted locations and predicted object boxes of the historical objects, determining the historical objects are in a static state or a moving state according to a heat map, wherein the heat map is generated according to the historical images, extracting current bounding boxes corresponding to current objects from current images, comparing and calculating similarity values between the predicted object boxes and the current bounding boxes respectively, corresponding one of the current objects to one of the historical objects when the similarity value is higher than a threshold value, generating a labelled object box, and using the labelled object box to update the heat map and at least one of the historical moving traces, wherein the labelled object box is in the static state or the moving state.

### CROSS-REFERENCE TO RELATED APPLICATIONS

This non-provisional application claims priority under 35 U.S.C. § 119 (a) on Patent Application No(s). 112132754 filed in Republic of China (ROC) on Aug. 30, 2023, the entire contents of which are hereby incorporated by reference.

### BACKGROUND

### 1. Technical Field

This disclosure relates to an object tracking method and device.

### 2. Related Art

Existing object tracking technology covers a variety of methods for detecting and tracking specific objects in video streams or continuous images. These technologies can be applied to various application fields, including street monitoring and autonomous driving.

However, when multiple objects are located close to each other leading to dense tracking results, it is possible that multiple objects are recognized as one large object. This situation is likely to occur for the same types of objects are close to each other, such as groups of cars or people waiting in images.

### SUMMARY

Accordingly, this disclosure provides an object tracking method and device.

According to one or more embodiment of this disclosure, an object tracking method, performed by a processor, includes; extracting a plurality of historical moving traces corresponding to a plurality of historical objects from a plurality of historical images, and predicting a plurality of predicted locations and a plurality of predicted object boxes of the plurality of historical objects; determining a state of each of the plurality of historical objects is one of a static state and a moving state according to a heat map, wherein the heat map is generated according to the plurality of historical images; extracting a plurality of current bounding boxes corresponding to a plurality of current objects from a current image, wherein the plurality of historical images and the current image are consecutive images obtained over a continuous period of time; comparing and calculating a similarity value between the plurality of predicted object boxes and the plurality of current bounding boxes respectively, and when the similarity value is higher than a threshold value, corresponding one of the plurality of current objects to one of the plurality of historical objects, and generating at least one labelled object box; and updating the heat map and at least one of the plurality of historical moving traces using the at least one labelled object box, wherein the at least one labelled object box is in the static state or the moving state.

According to one or more embodiment of this disclosure, an object tracking device includes: a camera element, a memory and a processor. The camera element is configured to obtain a plurality of consecutive images over a continuous period of time, wherein the plurality of consecutive images comprise a current image and a plurality of historical images. The memory is configured to store a plurality of historical objects, a plurality of historical moving traces and the plurality of consecutive images. The processor is connected to the camera element and the memory, and configured to perform: extracting the plurality of historical moving traces corresponding to the plurality of historical objects from the plurality of historical images, and predicting a plurality of predicted object boxes of the plurality of historical objects; determining a state of each of the plurality of historical objects is one of a static state and a moving state according to a heat map, wherein the heat map is generated according to the plurality of historical images; extracting a plurality of current bounding boxes corresponding to a plurality of current objects from the current image; comparing and calculating a similarity value between the plurality of predicted object boxes and the plurality of current bounding boxes respectively, and when the similarity value is higher than a threshold value, corresponding one of the plurality of current objects to one of the plurality of historical objects, and generating at least one labelled object box; and updating the heat map and at least one of the plurality of historical moving traces using the at least one labelled object box, wherein the at least one labelled object box is in the static state or the moving state.

In view of the above description, the object tracking method and device according to one or more embodiments of the present disclosure may avoid problems caused by frame skipping and inaccurate detection in object tracking, the situation of misjudgment caused by object boxes in the static state appearing densely in close locations may be reduced.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating an object tracking device according to an embodiment of the present disclosure;

FIG. 2 is a flow chart illustrating an object tracking method according to an embodiment of the present disclosure;

FIG. 3 is a schematic diagram illustrating historical object boxes, current bounding boxes and a predicted object box;

FIG. 4 is a schematic diagram illustrating a heat map according to an embodiment of the present disclosure;

FIG. 5 is a flow chart illustrating the method of assigning a current object of the object tracking method according to an embodiment of the present disclosure;

FIG. 6 is a flow chart illustrating the method of determining whether to remain a static object box of the object tracking method according to an embodiment of the present disclosure;

FIG. 7 is a flow chart illustrating the method of updating the heat map of the object tracking method according to an embodiment of the present disclosure;

FIG. 8(a) is a schematic diagram illustrating the heat map obtained by not using weighted calculation, and FIG. 8(b) is a schematic diagram illustrating the heat map obtained by using the weighted calculation; and

FIG. 9 is a flow chart illustrating the method of determining whether to delete an non-matching object of the object tracking method according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

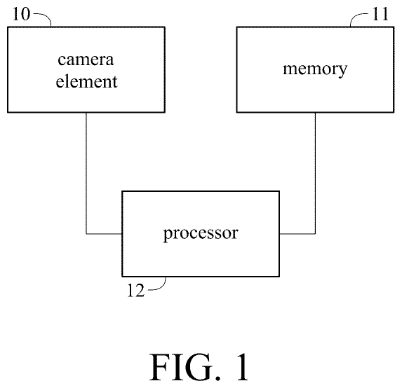

Please refer to FIG. 1, wherein FIG. 1 is a block diagram illustrating an object tracking device according to an embodiment of the present disclosure. As shown in FIG. 1, the object tracking device 1 includes a camera element 10, a memory 11 and a processor 12. The processor 12 is connected to the camera element 10 and the memory 11 in a wired or wireless way.

The camera element 10 is configured to obtain a plurality of consecutive images over a continuous period of time of the same scene, wherein the consecutive images comprise a current image and a plurality of historical images. For example, the camera element 10 may be a camera at a street intersection. The memory 11 is configured to store a plurality of historical objects, a plurality of historical moving traces and a plurality of images captured by the camera element 10. The historical objects may be objects of one or more types. Take street application as an example, the historical object may be a vehicle, a pedestrian, a motorcyclist etc. The historical object and the historical moving trace may be results obtained by the object tracking method described below or other object tracking methods prior to an image acquisition timing prior to the current image. The memory 11 may be a non-volatile memory (NVM), such as a read-only memory (ROM), a flash memory and/or non-volatile random-access memory (NVRM) etc. The processor 12 may include, but not limited to, a single processor and an integration of a plurality of microprocessors, such as a central processing unit, a graphic processing unit, a microcontroller, a programmable logic controller (PLC) or any other processors with signal processing function. The processor 12 is configured to use data stored by the memory 11 to perform object tracking, and steps performed by the processor 12 are described below.

The following description uses a timing t to refer to the image acquisition timing of the current image, uses the timings t-1 to t-n to refer to the image acquisition timings of the historical images, uses an image Dt to refer to the current image, and uses images Dt-1 to Dt-n to refer to the historical images, wherein n is a positive integer that is higher than 1.

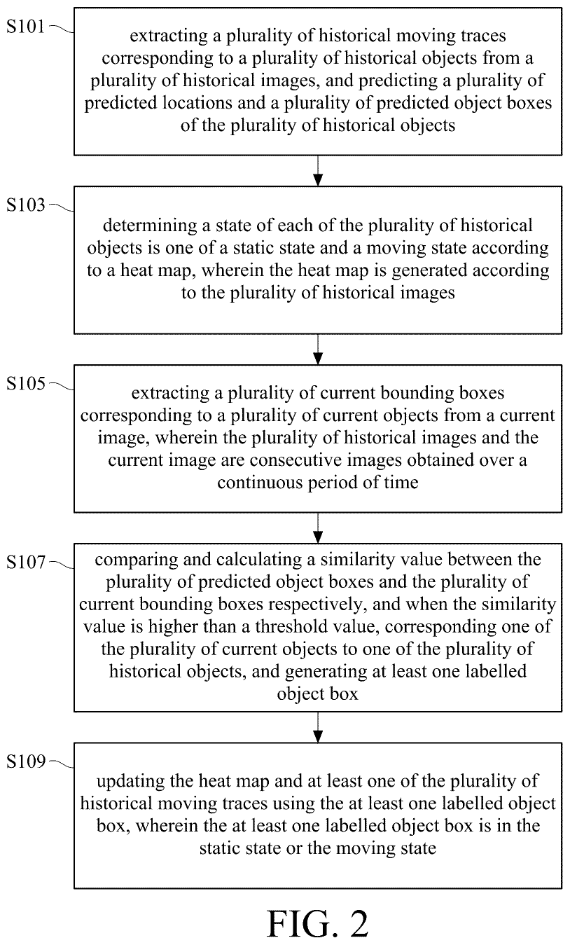

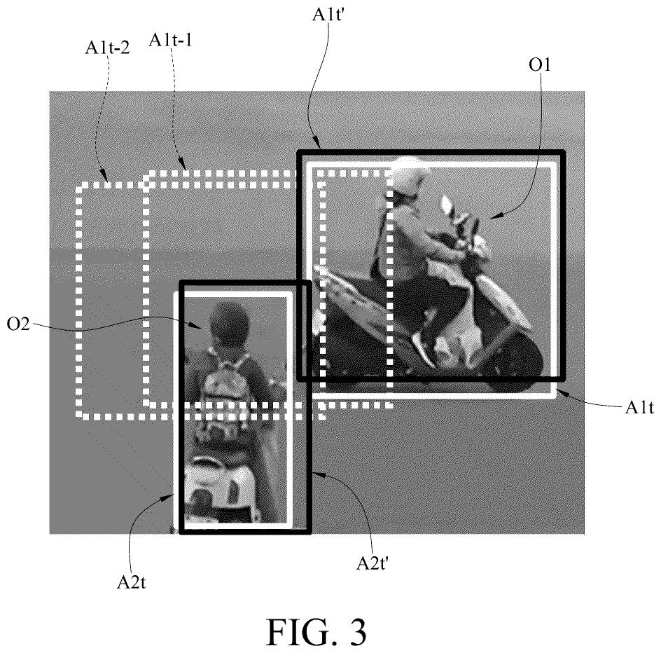

Please refer to FIG. 1 to FIG. 3, wherein FIG. 2 is a flow chart illustrating an object tracking method according to an embodiment of the present disclosure, and FIG. 3 is a schematic diagram illustrating historical object boxes, current bounding boxes and a predicted object box. The object tracking method shown in FIG. 2 may be performed by the object tracking device 1 of FIG. 1, and the object tracking method includes step S101 to step S109.

In step S101, the processor 12 extracts a plurality of historical moving traces corresponding to a plurality of historical objects from the images Dt-1 to Dt-n, and predicts a plurality of predicted locations and a plurality of predicted object boxes of the historical objects. Specifically, the historical moving trace of each historical object may include a plurality of historical locations and a plurality of historical object boxes from the timing t-1 to the timing t-n that the historical object corresponds to. The processor 12 may use the historical moving trace of each historical object and Kalman filter technology to obtain the predicted location and the predicted object box of each historical object at the timing t. As shown in FIG. 3, the historical object boxes Alt-2 and Alt-1 exemplarily show the historical object boxes of the historical object O1 at the timings t-1 and t-2. The processor 12 may use the historical object boxes Alt-2 and Alt-1 and their locations to predict the predicted object box A1t′ and the location of the historical object O1 at the timing t. FIG. 3 also exemplarily shows the predicted object box A2t′ of another historical object O2, and the method of generating the predicted object box A2t′ of another historical object O2 may be the same as that of the predicted object box A1t′ of the historical object O1.

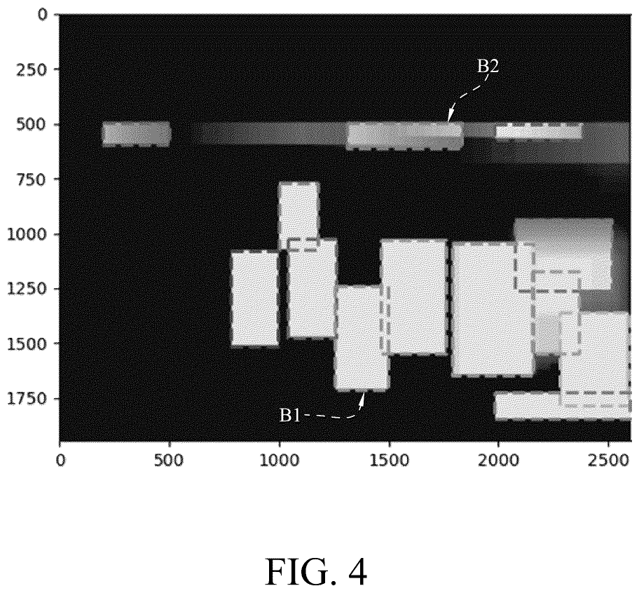

In step S103, the processor 12 determines a state of each of the historical objects is a static state or a moving state according to the heat map, wherein the heat map is generated according to the images Dt-1 to Dt-n. Specifically, the heat map is generated according to the accumulation of the historical object boxes in the images Dt-1 to Dt-n, and is used to indicate the probabilities of the historical objects presenting at each location in the image corresponding to the scene captured by the camera element 10. When an average probability corresponding to a range of one historical object box is higher than a preset threshold, the processor 12 determines that the historical object corresponding to the historical object box is in the static state; and when an average probability corresponding to a range of one historical object box is not higher than the preset threshold, the processor 12 determines that the historical object corresponding to the historical object box is in the moving state. The preset threshold is, for example, 95%, but the present disclosure is not limited thereto. Please also refer to FIG. 4, wherein FIG. 4 is a schematic diagram illustrating a heat map according to an embodiment of the present disclosure, and units of the horizontal axis and the vertical axis are pixel. In FIG. 4, grey scale value may indicate probability. A grey scale value of the first object box B1 is higher than the preset threshold, and the corresponding object is determined as in the static state. A grey scale value of the second object box B2 is not higher than the preset threshold, and the corresponding object is determined as in the moving state. It should be noted that, FIG. 4 exemplarily presents the heat map in gray scale, but in other embodiments, the heat map may be a colored map, or may be a matrix formed of a plurality of probabilities.

In step S105, the processor 12 extracts a plurality of current bounding boxes corresponding to a plurality of current objects from the image Dt. Specifically, the processor 12 may use trained neural model to perform object detection on the image Dt to obtain the current bounding boxes of the current objects. The neural model especially is a you-only-look-once model (YOLO). Take street application as an example, the trained neural model may be a model capable of identifying common objects on the road, such as cars, motorcyclists and pedestrians etc. Then, in step S107, the processor 12 compares and calculates a similarity value between each of the predicted object boxes and the corresponding current bounding box, and corresponds one of the current objects to one of the historical objects when the similarity value is higher than the threshold value to generate at least one labelled object box. Specifically, the processor 12 may use intersection over union (IOU) to calculate the similarity value, and the step of corresponding the current object to the historical object according to the similarity value to generate the labelled object box may be performed by Hungarian algorithm. The labelled object box may include the current bounding box and a corresponding label of the historical objects. The threshold value is, for example, 95%.

As shown in FIG. 3, the bounding boxes Alt and A2t exemplarily present the current bounding boxes of two motorcyclists (two current objects) obtained by the processor 12 performing object detection on the image Dt. The processor 12 may compare and calculate the similarity values between the current bounding boxes Alt and A2t and the predicted object boxes A1t′ and A2t′, respectively. The processor 12 may generate a labelled object box when determining that the similarity value between the current bounding box Alt and the predicted object box A1t′ is higher than the threshold value, wherein the labelled object box indicates the current object corresponding to the current bounding box Alt corresponds to the historical object O1. The processor 12 may generate another labelled object box when determining that the similarity value between the current bounding box A2t and the predicted object box A2t′ is higher than the threshold value, wherein said another labelled object box indicates the current object corresponding to the current bounding box A2t corresponds to the historical object O2.

In step S109, the processor 12 uses the labelled object box to update the heat map and at least one of the historical moving traces, especially the historical moving trace of the at least one historical object corresponding to the at least one labelled object box generated in step S105. The state of the labelled object box is the static state or the moving state. Specifically, the processor 12 may overlay the labelled object box to the heat map and perform an average calculation to update the distribution of the probability values in the heat map.

It should be noted that, FIG. 3 exemplarily shows the historical object boxes, the predicted object boxes and the current bounding boxes in the same picture for description convenience, and is not intended to limit the object tracking method of the present disclosure generating the picture shown in FIG. 3. In addition FIG. 3 exemplarily shows motorcyclist as the object, but the present disclosure is not limited to this type of object.

According to the above description, the object tracking method and device according to one or more embodiments of the present disclosure may avoid problems caused by frame skipping or inaccurate detection in object tracking, and may effectively distinguish whether the object is in the static state or in the moving state. Therefore, the probability of misjudgment of the state of the object, which caused by object boxes in the static state appearing densely in close locations, may be reduced.

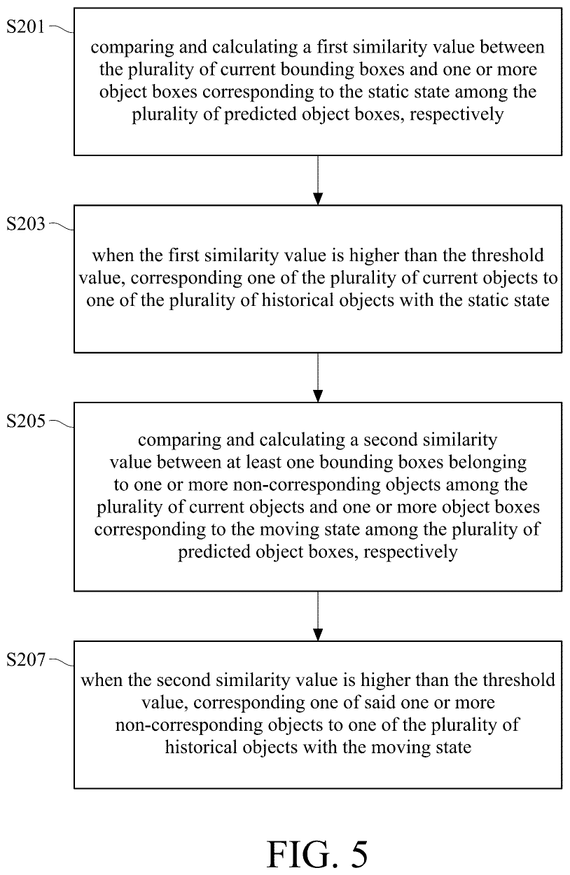

Please refer to FIG. 1, FIG. 3 and FIG. 5, wherein FIG. 5 is a flow chart illustrating the method of assigning a current object of the object tracking method according to an embodiment of the present disclosure. FIG. 5 may be regarded as a detail flow chart of an implementation of step S107 of FIG. 2. As shown in FIG. 5, method of assigning the current object may include step S201 to step S207. The following exemplarily describes step S201 to step S207 with FIG. 3, wherein it is assumed that the heat map presents the historical object O2 corresponding to the predicted object box A2t′ is in the static state and the historical object O1 corresponding to the predicted object box A1t′ is in the moving state.

In step S201, the processor 12 compares and calculates a first similarity value between each of the current bounding boxes Alt and A2t and the predicted object box A2t′ corresponding to the static state among the predicted object boxes A1t′ and A2t′, respectively. The method of calculating the first similarity values may be using intersection over union (IOU) as described above, and its description is not repeated herein. Specifically, the processor 12 may determine which one (or more) of the predicted object boxes A1t′ and A2t′ corresponds to the static state according to the heat map.

In step S203, the processor 12 may determine that the current object corresponding to the current bounding box A2t corresponds to the historical object O2 in the static state when determining that the first similarity value between the predicted object box A2t′ and the current bounding box A2t is higher than the threshold value. The threshold value is, for example, 95%.

In step S205, the processor 12 compares and calculates a second similarity value between the current bounding box Alt of a non-corresponding object and the predicted object box A1t′ corresponding to the moving state among the predicted object boxes A1t′ and A2t′, respectively. The method of calculating the second similarity value may be using intersection over union (IOU) as described above, and its description is not repeated herein. The non-corresponding object indicates other current object that is determined as not corresponding to the historical objects in the static state in step S203. Specifically, the processor 12 may determine which predicted object box among all of predicted object boxes A1t′ and A2t′ corresponds to the moving state according to the heat map.

In step S207, the processor 12 may determine that the current object corresponding to the current bounding box Alt corresponds to the historical object O1 in the static state when determining that the second similarity value between the predicted object box A1t′ and the current bounding box Alt is higher than said threshold value.

Step S203 and step S207 may be performed by using Hungarian algorithm, the details are not described herein. Although FIG. 3 exemplarily shows one predicted object box corresponding to the static state and one predicted object box corresponding to the moving state, step S201 to S207 may also be embodied on predicted object boxes corresponding to the static state or/and predicted object boxes corresponding to the moving state. Step S201 to step S207 may be regarded as assigning the static object before assigning the moving object.

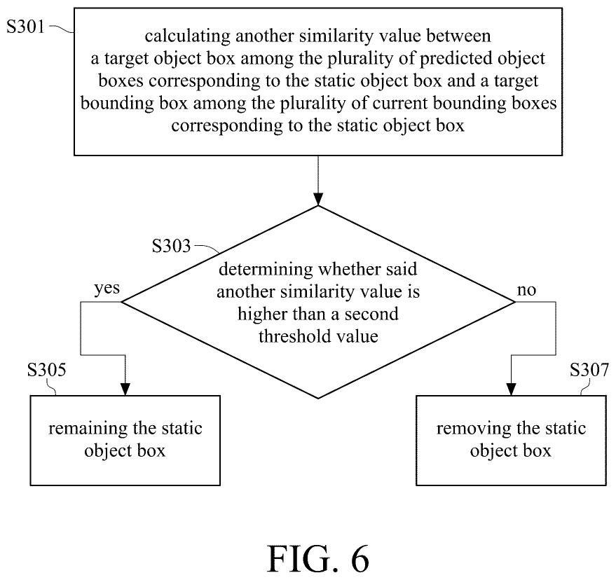

Please refer to FIG. 1, FIG. 3 and FIG. 6, wherein FIG. 6 is a flow chart illustrating the method of determining whether to remain a static object box of the object tracking method according to an embodiment of the present disclosure. Steps shown in FIG. 6 may be performed between step S107 and step S109 of FIG. 2. As shown in FIG. 6, after generating the labelled object box, the processor 12 may further perform step S301 to step S307. It should be noted that, in the embodiment of FIG. 6, the labelled object box generated in step S107 includes a static object box, meaning the labelled object box corresponds to a historical object that is in the static state.

In step S301, the processor 12 calculates the similarity value between one of the predicted object boxes (target object box) corresponding to the static object box and one of the current object boxes (target bounding box) in the current image Dt corresponding to the same static object box.

In step S303, the processor 12 determines whether the similarity value between the target object box and the target bounding box is higher than another threshold value (referred to as “second threshold value” hereinafter). Specifically, the second threshold value may be the same as the threshold value described in step S107 of FIG. 2. When the similarity value between the target object box and the target bounding box is higher than the second threshold value, the processor 12 performs step S305 to remain the static object box of the labelled object box. On the contrary, when the similarity value between the target object box and the target bounding box is not higher than the second threshold value, the processor 12 performs step S307 to remove the static object box. Furthermore, the method of implementing step S307 may be removing the label corresponding to the static object box to restore the static object box back to the current bounding box with the current object that is not yet corresponded to.

The following use FIG. 3 to explain step S301 to S307. Assuming that the assigning result of step S107 is the current bounding box At1 corresponding to the historical object O1 in the moving state and the current bounding box At2 corresponding to the historical object O2 in the static state. In step S301 and step S305, the processor 12 may compare and calculate the similarity value between the current bounding box At1 and the predicted object box At1′, and compare the calculated similarity value with the second threshold value. If the similarity value between the current bounding box At1 and the predicted object box At1′ is higher than the second threshold value, the labelled object box containing the label of the historical object O2 is kept, and on the contrary, the labelled object box containing the label of the historical object O2 is removed.

Step S107 and steps 301 to S307 may be regarded as first assigning all of the historical objects, then verifying the assigning result of the static objects.

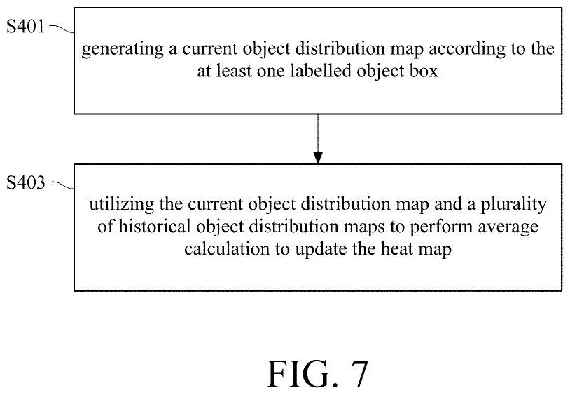

Please refer to FIG. 1 and FIG. 7, wherein FIG. 7 is a flow chart illustrating the method of updating the heat map of the object tracking method according to an embodiment of the present disclosure. FIG. 7 may be regarded as a detail flow chart of an implementation of updating the heat map in step S109 of FIG. 2. As shown in FIG. 7, the method of updating the heat map may include step S401 and step S403.

In step S401, the processor 12 generates a current object distribution map according to the labelled object box. Specifically, the current object distribution map may include one or more labelled object boxes, and location of each labelled object box in the current object distribution map is the same as location of the respective current bounding box in the current image Dt.

In step S403, the processor 12 utilizes the current object distribution map and historical object distribution maps to perform an average calculation to update the heat map. Furthermore, the processor 12 may perform the average calculation on a coverage of the labelled object box in the current object distribution map and a coverage of the historical object box in the distribution map of each the historical object. The historical object distribution map is generated according to a corresponding one of the historical images Dt-1 to Dt-n, and the method of generating the historical object distribution map is the same as the current object distribution map. Take the historical image Dt-1 as an example, the corresponding historical object distribution map may include one or more historical object boxes, and location of each historical object box in the historical object distribution map is the same as the location of the historical object box in the historical image Dt-1.

Said average calculation may be performed on the areas of the coverages, said average calculation may also be performed on the probability values corresponding to the object boxes. For example, the processor 12 may assign each labelled object box in the current object distribution map with the same probability value (such as, 1), and each historical object box in each historical object distribution map may also be assigned with the same probability value (such as, 1). Therefore, in step S403, the processor 12 may perform the average calculation based on the probability value of each labelled object box of the current object distribution map and the probability value of the historical object boxes of each one of the historical object distribution maps, and use the result of the average calculation as the updated heat map.

The method of implementing step S403 may further include the processor 12 performing the average calculation on the current object distribution map and the historical object distribution maps excluding one of the historical object distribution maps corresponding to an earliest timing when the number of the historical object distribution maps is higher than a default number. The default number may be 29, but the present disclosure is not limited thereto. In other words, take the default number being 29 as an example, the processor 12 may utilize the latest 29 historical object distribution maps and the current object distribution map to perform the average calculation, and utilize the result of the average calculation as the updated heat map.

In addition, the average calculation may further be a weighted average calculation, and a weight of the current object distribution map is higher than the weights of the historical object distribution maps. The processor 12 may assign the current object distribution map with a weight higher than 1, and assign the historical object distribution maps with weights equal to or lower than 1. In addition, the method of calculating the weight of the current object distribution map may also be multiplying the total number of the historical object distribution maps and the current object distribution map with a default ratio. Take the default number being 29 as an example, the total number is 30, and the default ratio is 0.1, then the weight of the current object distribution map may be 3. Accordingly, the updated heat map may more realistically present the moving and static states of the current object.

Also, if there are multiple labelled object boxes, then before performing the average calculation, the processor 12 may use the union of the labelled object boxes, then use the unionized current object distribution map to perform the average calculation. Accordingly, the overlapping region between the labelled object boxes may be avoided from having probability value that is too high.

Further, a resolution of the current object distribution map may be lower than a resolution of the current image. Specifically, after generating the labelled object box, the processor 12 may map the labelled object box onto a picture with lower resolution, thereby reducing computing energy consumption of the processor 12 and reducing the required storage space.

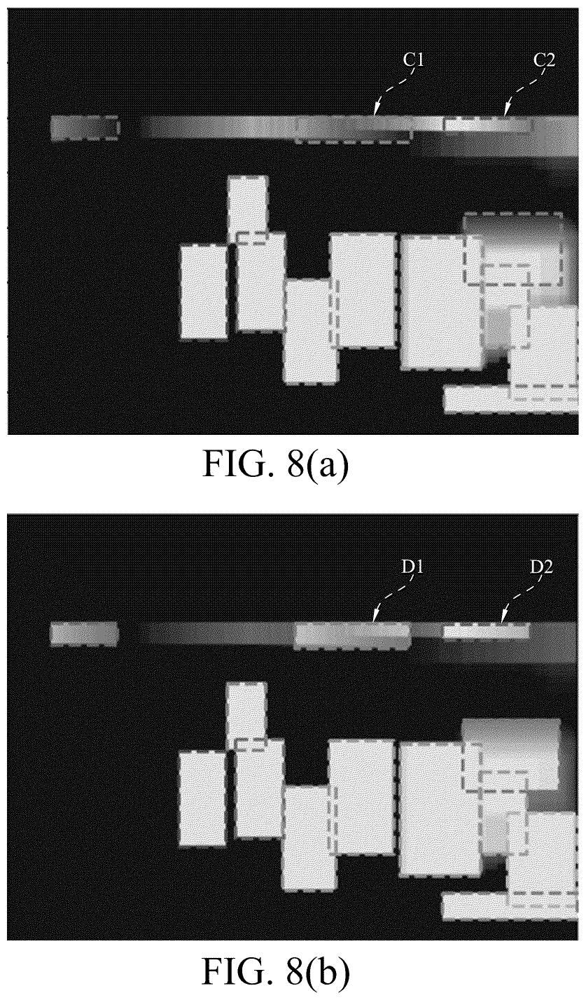

Please refer to FIG. 8(a) and FIG. 8(b), wherein FIG. 8(a) is a schematic diagram illustrating the heat map obtained by not using weighted calculation, FIG. 8(b) is a schematic diagram illustrating the heat map obtained by using the weighted calculation according to one or more embodiments described above. As seen from FIG. 8(a), the coverages of an object box C1 and an object box C2 do not entirely correspond to the current locations of the objects. As seen from FIG. 8(b), the two objects (the two brighter parts) match with the coverage of the object box D1 and the coverage of the object box D2, respectively. It can be known from FIG. 8(a) and FIG. 8(b) that, the heat map obtained by performing weight calculation may clearly highlight the location of the object at the current timing.

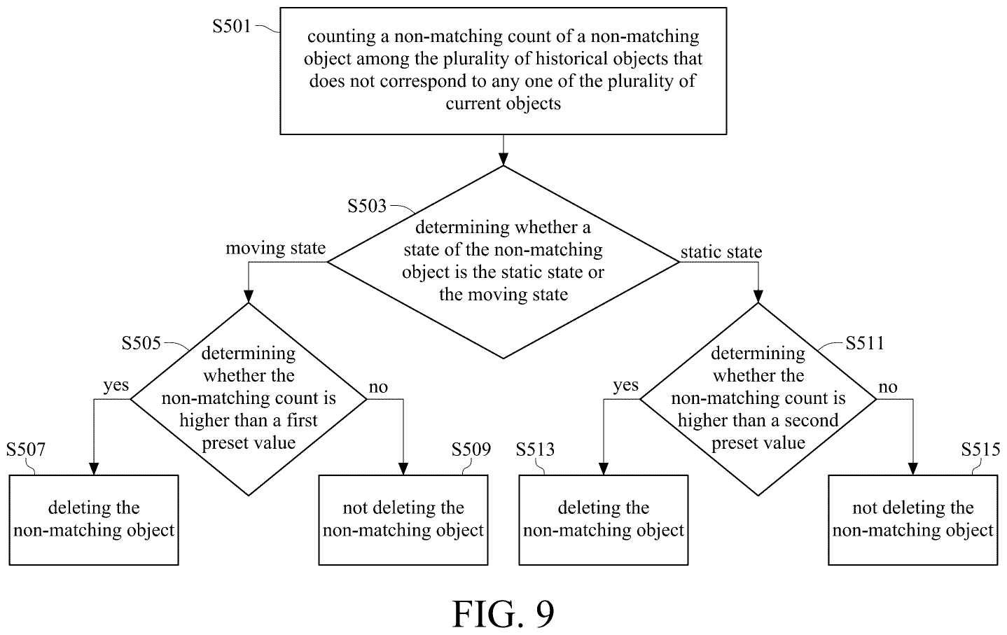

Please refer to FIG. 1 and FIG. 9, wherein FIG. 9 is a flow chart illustrating the method of determining whether to delete a non-matching object of the object tracking method according to an embodiment of the present disclosure. Step S501 to step S515 shown in FIG. 9 may be performed after step S107 of FIG. 2, and the present disclosure does not limit the sequence of step S501 to step S515 and step S109 of FIG. 2.

In step S501, the processor 12 counts a non-matching count of the historical object (referred to as “non-matching object” hereinafter) among the historical objects that does not correspond to any one of the current objects, wherein an initial value of the non-matching count is 0. For example, take the historical image Dt-1 as an example, if a first historical object in the historical image Dt-1 does not match with any one of the current objects in the current image Dt, the processor 12 may use the first historical object as the non-matching object, and adds 1 to the non-matching count. Then, if the non-matching object still does not match with any one of the current objects in the next image following the current image Dt, the processor 12 again adds 1 to the non-matching count.

In step S503, the processor 12 determines a state of the non-matching object is one of the static state and the moving state. If the non-matching object is in the moving state, the processor 12 performs step S505 to further determine whether the non-matching count is higher than a first preset value. If the non-matching count is higher than the first preset value, the processor 12 performs step S507 to delete the non-matching object, wherein the method of deleting the non-matching object may be deleting the object box of the non-matching object. If the non-matching count is not higher than the first preset value, the processor 12 performs step S509 to not delete the non-matching object, meaning remaining the non-matching object.

Please refer to step S503 again, if the non-matching object is in the static state, the processor 12 performs step S511 to further determine whether the non-matching count is higher than a second preset value. If the non-matching count is higher than the second preset value, the processor 12 performs step S513 to delete the non-matching object. On the contrary, if the non-matching count is not higher than the second preset value, the processor 12 performs step S515 to remaining the non-matching object. The method of implementing step S513 may be the same as step S507, and the method of implementing step S515 may be the same as step S509.

It should be noted that, the second preset value is higher than the first preset value, wherein the first preset value is, for example, 10, and the second preset value is, for example, 20, but the present disclosure is not limited thereto. By setting the second preset value higher than the first preset value, the possibility of an object which is actually in the moving state being mistakenly deleted, due to the object temporarily stays (such as, waiting for the red light) may be reduced. Accordingly, for an object that remains in place after being occluded, the ability of the object to be determined as at its original location may be increased.

In view of the above description, the object tracking method and device according to one or more embodiments of the present disclosure are disclosed, problems, such as frame skipping or inaccurate detection, in object tracking may be reduced, and misjudgments of the state of the object, which caused by object boxes in the static state appearing densely in close locations, may be reduced. Further, the method of updating the heat map according to one or more embodiments of the present disclosure may allow the updated heat map to present the moving and static states of the current object more realistically, the overlapping region between the labelled object boxes may be avoided from having probability value that is too high, and computing energy consumption of the processor performing the average calculation may be reduced. In addition, according to one or more embodiments of the present disclosure of the method of determining whether to delete the non-matching object, the probability of an object which is actually in the moving state being mistakenly deleted because the object stops moving temporarily (such as, waiting for the red light) may be reduced. The object tracking method and device according to one or more embodiments of the present disclosure may be used to detect and track vehicle image, and improve the tracking accuracy when the vehicle is in the static state.

What is claimed is:

1. An object tracking method, performed by a processor, comprising:
extracting a plurality of historical moving traces corresponding to a plurality of historical objects from a plurality of historical images, and predicting a plurality of predicted locations and a plurality of predicted object boxes of the plurality of historical objects;
determining a state of each of the plurality of historical objects is one of a static state and a moving state according to a heat map, wherein the heat map is generated according to the plurality of historical images;
extracting a plurality of current bounding boxes corresponding to a plurality of current objects from a current image, wherein the plurality of historical images and the current image are consecutive images obtained over a continuous period of time;
comparing and calculating a similarity value between the plurality of predicted object boxes and the plurality of current bounding boxes respectively, and when the similarity value is higher than a threshold value, corresponding one of the plurality of current objects to one of the plurality of historical objects, and generating at least one labelled object box; and
updating the heat map and at least one of the plurality of historical moving traces using the at least one labelled object box, wherein the at least one labelled object box is in the static state or the moving state.

2. The object tracking method according to claim 2, wherein updating the heat map comprises:
generating a current object distribution map according to the at least one labelled object box; and
utilizing the current object distribution map and a plurality of historical object distribution maps to perform average calculation to update the heat map;
wherein each of the plurality of historical object distribution maps corresponds to a corresponding historical image of the plurality of historical images, and each of the plurality of historical object distribution maps comprises at least one historical object box extracted from the corresponding historical image.

3. The object tracking method according to claim 2, wherein utilizing the current object distribution map and the plurality of historical object distribution maps to perform the average calculation comprises:
performing the average calculation on the current object distribution map and the plurality of historical object distribution maps excluding ahistorical object distribution map corresponding to an earliest timing when a number of the plurality of historical object distribution maps is higher than a default number.

4. The object tracking method according to claim 2, wherein the average calculation is a weighted average calculation, and a weight of the current object distribution map is higher than a weight of the plurality of historical object distribution maps.

5. The object tracking method according to claim 2, wherein when a number of the at least one labelled object box is more than one, the current object distribution map comprises a union of the at least one labelled object box.

6. The object tracking method according to claim 2, wherein a resolution of the current object distribution map is smaller than a resolution of the current image.

7. The object tracking method according to claim 1, wherein comparing and calculating the similarity value between the plurality of predicted object boxes and the plurality of current bounding boxes respectively, and when the similarity value is higher than the threshold value, corresponding said one of the plurality of current objects to said one of the plurality of historical objects comprises:
comparing and calculating a first similarity value between the plurality of current bounding boxes and one or more object boxes corresponding to the static state among the plurality of predicted object boxes, respectively;
when the first similarity value is higher than the threshold value, corresponding one of the plurality of current objects to one of the plurality of historical objects with the static state;
comparing and calculating a second similarity value between at least one bounding boxes belonging to one or more non-corresponding objects among the plurality of current objects and one or more object boxes corresponding to the moving state among the plurality of predicted object boxes, respectively; and
when the second similarity value is higher than the threshold value, corresponding one of said one or more non-corresponding objects to one of the plurality of historical objects with the moving state.

8. The object tracking method according to claim 1, wherein the at least one labelled object box comprises a static object box, the static object box is in the static state, and the method further comprises:
calculating another similarity value between a target object box among the plurality of predicted object boxes corresponding to the static object box and a target bounding box among the plurality of current bounding boxes corresponding to the static object box;
remaining the static object box when the another similarity value is higher than a second threshold value; and
removing the static object box when the another similarity value is not higher than the second threshold value.

9. The object tracking method according to claim 1, further comprising:
counting a non-matching count of a non-matching object among the plurality of historical objects that does not correspond to any one of the plurality of current objects;
when the non-matching object is in the moving state, determining to delete the non-matching object if the non-matching count is higher than a first preset value; and
when the non-matching object is in the static state, determining to delete the non-matching object if the non-matching count is higher than a second preset value;
wherein the second preset value is higher than the first preset value.

10. An object tracking device, comprising:
a camera element configured to obtain a plurality of consecutive images over a continuous period of time, wherein the plurality of consecutive images comprise a current image and a plurality of historical images;
a memory configured to store a plurality of historical objects, a plurality of historical moving traces and the plurality of consecutive images; and
a processor connected to the camera element and the memory, and configured to perform:
extracting the plurality of historical moving traces corresponding to the plurality of historical objects from the plurality of historical images, and predicting a plurality of predicted object boxes of the plurality of historical objects;
determining a state of each of the plurality of historical objects is one of a static state and a moving state according to a heat map, wherein the heat map is generated according to the plurality of historical images;
extracting a plurality of current bounding boxes corresponding to a plurality of current objects from the current image;
comparing and calculating a similarity value between the plurality of predicted object boxes and the plurality of current bounding boxes respectively, and when the similarity value is higher than a threshold value, corresponding one of the plurality of current objects to one of the plurality of historical objects, and generating at least one labelled object box; and
updating the heat map and at least one of the plurality of historical moving traces using the at least one labelled object box, wherein the at least one labelled object box is in the static state or the moving state.

11. The object tracking device according to claim 10, wherein the processor is configured to:
generate a current object distribution map according to the at least one labelled object box; and
utilize the current object distribution map and a plurality of historical object distribution maps to perform average calculation to update the heat map;
wherein each of the plurality of historical object distribution maps corresponds to a corresponding historical image of the plurality of historical images, and each of the plurality of historical object distribution maps comprises at least one historical object box extracted from the corresponding historical image.

12. The object tracking device according to claim 11, wherein the processor is configured to perform the average calculation on the current object distribution map and the plurality of historical object distribution maps excluding one of plurality of historical object distribution maps corresponding to an earliest timing when a number of the plurality of historical object distribution maps is higher than a default number.

13. The object tracking device according to claim 11, wherein the average calculation is a weighted average calculation, and a weight of the current object distribution map is higher than a weight of the plurality of historical object distribution maps.

14. The object tracking device according to claim 11, wherein when a number of the at least one labelled object box is more than one, the current object distribution map comprises a union of the at least one labelled object box.

15. The object tracking device according to claim 11, wherein a resolution of the current object distribution map is smaller than a resolution of the current image.

16. The object tracking device according to claim 10, wherein the processor is configured to:
compare and calculate a first similarity value between the plurality of current bounding boxes and one or more object boxes corresponding to the static state among the plurality of predicted object boxes, respectively;
when the first similarity value is higher than the threshold value, correspond one of the plurality of current objects to one of the plurality of historical objects with the static state;
compare and calculate a second similarity value between at least one bounding boxes belonging to one or more non-corresponding objects among the plurality of current objects and one or more object boxes corresponding to the moving state among the plurality of predicted object boxes, respectively; and
when the second similarity value is higher than the threshold value, correspond one of said one or more non-corresponding objects to one of the plurality of historical objects with the moving state.

17. The object tracking device according to claim 10, wherein the at least one labelled object box comprises a static object box, the static object box is in the static state, and the processor is further configured to perform:
calculating another similarity value between a target object box among the plurality of predicted object boxes corresponding to the static object box and a target bounding box among the plurality of current bounding boxes corresponding to the static object box;
remaining the static object box when the another similarity value is higher than a second threshold value; and
removing the static object box when the another similarity value is not higher than the second threshold value.

18. The object tracking device according to claim 10, the processor is further configured to perform:
counting a non-matching count of a non-matching object among the plurality of historical objects that does not correspond to any one of the plurality of current objects;
when the non-matching object is in the moving state, determining to delete the non-matching object if the non-matching count is higher than a first preset value; and
when the non-matching object is in the static state, determining to delete the non-matching object if the non-matching count is higher than a second preset value;
wherein the second preset value is higher than the first preset value.
